(19) United States
(12) Patent Application Publication
(10) Pub. No.: US 2009/0279384 A1
(43) Pub. Date: Nov. 12, 2009

(54) Control Methods for Distributed Nodes

(75) Inventor: Dennis R. Pavel, Highland Village, TX (US)

Correspondence Address: PAUL S MADAN;MADAN & SRIRAM, PC, 2603 AUGUSTA DRIVE, SUITE 700, HOUSTON, TX, 77057-5662, US

(73) Assignee: ION GEOPHYSICAL CORPORATION, Houston, TX (US)

(21) Appl. No.: 12/116,836

(22) Filed: May 7, 2008

(51) Int. Cl. G01V 1/20

(52) U.S. Cl. 367/14

(57) ABSTRACT

A method of controlling distributed devices includes configuring the devices to respond to a controlled signal; positioning the devices in an area of interest; and transmitting the controlled signal into the earth. The earth acts as the signal transmission medium. The method may include controlling a signal generator with a controller to transmit the controlled signal. An illustrative controlled signal may have a fixed frequency, a fixed amplitude, a fixed wave form, a modulated frequency, a modulated amplitude, a modulated wave form, and/or a predetermined duration. In aspects, the method may include connecting the signal generator to the earth and transmitting the controlled signal into the earth using the signal generator. Afterwards, the signal generator may be operated to impart seismic energy into the earth. The devices may be used to detect and record seismic energy that has reflected from underground formations.

### CROSS-REFERENCE TO RELATED APPLICATIONS

None.

### BACKGROUND OF THE DISCLOSURE

In some applications, a device configured to execute one or more desired operations may be positioned at a remote location. For simplicity, such devices may be referred to as a node. While a node may be self-actuating, it may also be desirable to alter or adjust operation of the node. Typically, a control device may issue control signals to the node via cables or using radio signals. In some situations, however, the node may be positioned at a considerable distance from the control device or the environment may be inhospitable to communication cables or radio frequency transmissions. In other situations, there may be hundreds or thousands of nodes scattered over a wide geographical area, which may make using cables impractical and may make using transceivers expensive or overly complex. Thus, what is needed is a communication system that may provide a communication link with a node or node(s) but that does not rely on above surface transmission media or wire media.

Conventional control systems typically utilize cables or radio transmissions to exchange data and/or signals between distributed nodes and a control facility. The present disclosure addresses the need for control of distributed nodes that reduces the need for such communication devices.

### SUMMARY OF THE DISCLOSURE

In aspects, the present disclosure provides a method of controlling a plurality of devices. The devices may be any device that is autonomous, semi-autonomous, or passive and may include mechanically actuated devices, electronic devices, etc. In one embodiment, the method includes configuring the plurality of devices to respond to a controlled signal; positioning the plurality of devices in an area of interest; and transmitting the controlled signal into the earth. In aspects, the method may include encoding the controlled signal with an instruction to operate in a desired operating state. The method may also include encoding the controlled signal with data; and processing the controlled signal to select the operating state. In arrangements, the method may include controlling a signal generator to transmit the controlled signal. The signal generator may be a vibrating device. Exemplary vibrating devices may utilize a hydraulic actuator, a pneumatic actuator, and/or an electric actuator. In arrangements, the method may further include programming a controller to control the signal generator. An illustrative controlled signal may have: a fixed frequency; a fixed amplitude, a fixed wave form, a modulated frequency, a modulated amplitude, a modulated wave form, and/or a predetermined duration. In aspects, the method may include positioning the signal generator at the region of interest; transmitting the controlled signal into the earth using the signal generator; operating the signal generator to impart seismic energy into the earth; and detecting seismic data using one or more of the devices. One or more of the devices may shift into a recording mode of operation upon detecting the seismic energy. In some applications, the seismic energy may be seismic waves that have reflected from an underground formation.

In aspects, the present disclosure provides a system for remotely controlling devices by using the earth as a signal transmission medium. The system may include a plurality of nodes configured to select an operating state in response to receiving a controlled signal; and a signal generator configured to transmit the controlled signal into an earthen formation. The system may further include a processor configured to control the signal generator. The processor may be programmed with instructions to operate the signal generator to transmit the controlled signal. The controlled signal may include one or more of: (i) a fixed frequency; (ii) a fixed amplitude, (iii) a fixed wave form, (iv) a modulated frequency, (v) a modulated amplitude, and (vi) a modulated wave form. In arrangements, the signal generator may be configured to impart seismic energy into the earthen formation. In arrangements, each device may include a receiver configured to sense seismic vibrations, and the system may include a processor associated with each device. The processor may be programmed with instructions to control its associated device in response to signals detected by the receiver.

In aspects, the present disclosure also provides a method of controlling a plurality of nodes. The method may include operably coupling each node to a node controller; configuring each node controller to respond to a controlled signal; positioning the plurality of nodes in an area of interest; connecting each node to the earth; operably coupling a controller to a signal generator; connecting the signal generator to the earth; and controlling the signal generator with the controller to transmit the controlled signal into the earth. In aspects, each node controller may select an operating state from a plurality of different operating states based on the controlled signal. In arrangements, the method may include detecting the controlled signal with a seismic sensor. In aspects, the method may further include recording seismic data at each of the plurality of nodes. Also, in certain applications, the nodes may be positioned in an asymmetric pattern.

It should be understood that examples of the more important features of the disclosure have been summarized rather broadly in order that detailed description thereof that follows may be better understood, and in order that the contributions to the art may be appreciated. There are, of course, additional features of the disclosure that will be described hereinafter and will form the subject of the claims appended hereto.

### BRIEF DESCRIPTION OF THE DRAWINGS

The novel features of this disclosure, as well as the disclosure itself, will be best understood from the attached drawings, taken along with the following description, in which similar reference characters refer to similar parts, and in which:

FIG. 1 schematically illustrates one embodiment of a system that utilizes an earthen formation as a transmission medium for transmitting control signals;

FIG. 2 graphically illustrates exemplary control signals;

FIG. 3A schematically illustrates an exemplary seismic data acquisition node according to one embodiment of the present disclosure;

FIG. 3B schematically illustrates an exemplary seismic data acquisition source according to one embodiment of the present disclosure; and

FIG. 4 schematically illustrates a node-based seismic data acquisition system that utilizes the teachings of the present disclosure.

### DETAILED DESCRIPTION OF THE DISCLOSURE

In aspects, the present disclosure relates to devices and methods for controlling activities relating to seismic data acquisition. The present disclosure is susceptible to embodiments of different forms. There are shown in the drawings, and herein will be described in detail, specific embodiments of the present disclosure with the understanding that the present disclosure is to be considered an exemplification of the principles of the disclosure, and is not intended to limit the disclosure to that illustrated and described herein.

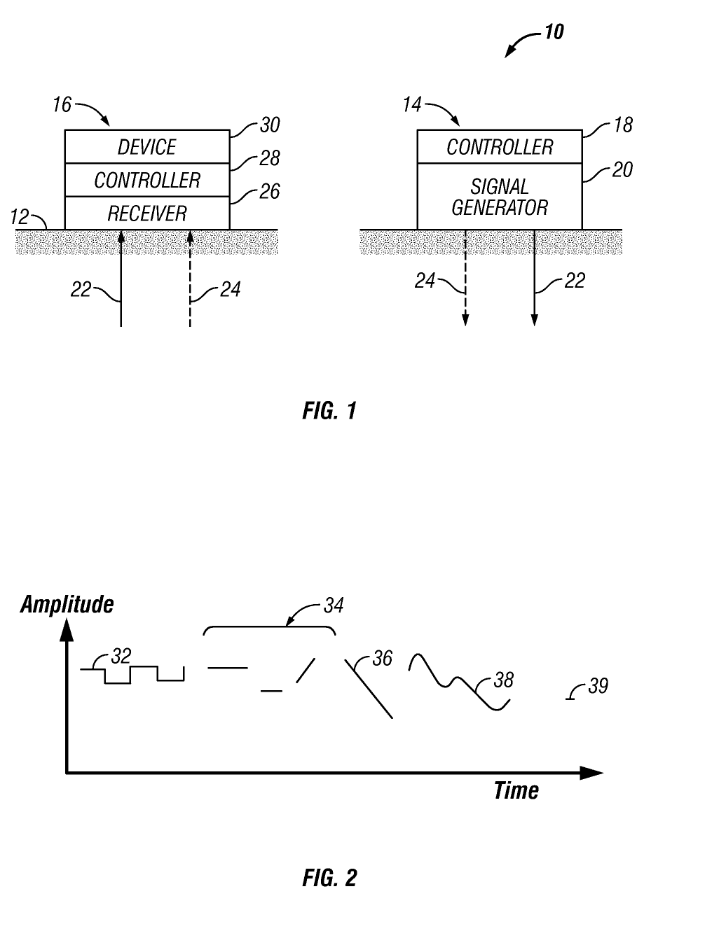

Referring to FIG. 1, there is schematically illustrated one embodiment of a system 10 that utilizes an earthen formation 12 as a transmission medium for transmitting control signals to one or more remote units. The system 10 may include a signal transmission device 14 and a remote unit that, for simplicity, will be referred to as a node 16. The signal transmission device 14 may include a controller 18 and a signal generator 20 for imparting seismic energy into the earthen formation 12. For purposes of this disclosure, the term seismic energy refers to energy waves that travel through the earth. The signal generator 20 may be configured to transmit seismic waves 22 as well as encoded energy waves 24 into the earthen formation. The waves 22 and 24 have been shown separately merely for clarity. Wave 24 differs from wave 22 in that the node 16 may change operating states upon receipt of the wave 24. Wave 22, however, is not a command signal and, when received at the node 16, does not initiate a change in operating states of the node 16. That is, wave 22 is specifically designed or shaped to furnish information regarding characteristics of a subsurface formation. In contrast, wave 24 is specifically designed or shaped to instruct the node 16 to take a specified action.

The node 16 may include a controller 28 and a receiver 26. The receiver 24 may be configured to detect seismic energy, including the waves 22 and 24, and transmit representative data signals to the controller 24. The controller 28 may be configured to process the transmitted data signals and, if needed, take responsive action. As will be discussed in greater detail below, such action may include changing an operating state of a device 26. The device 26 may be any device such as a camera, flood lights, alarms, actuators that move gates or barriers. Merely for simplicity, the device 26 will be discussed as a recording unit for storing data relating to the seismic energy detected by the receiver 26.

Referring now to FIG. 2, there are shown illustrative encoded signals that may be used to control the node 16. As used herein, the term ‘encoding’ generally refers to characterizing or shaping the signal in a desired manner. Characterization may include aspects such as a wave shape or form, duration, wave amplitude, wave frequency, pattern, etc. In aspects, encoding utilizes control over the signal generator in order to produce a signal having the desired characteristics. As shown, illustrative signals may include a step wave 32, a pulsed signal 34, a linear wave 36, a sinusoidal-type wave 38, a short-duration energy burst 39, etc. By way of example, the duration, frequency, amplitude and number of these waves may be controlled to produce a signal having a pre-determined pattern.

In an exemplary mode of operation, the controller 28 may be pre-programmed with one or more pre-determined signal patterns and further programmed to process the data provided by the receiver 26 to identify whether a particular signal matches one or more of the pre-determined patterns. For example, a first pre-determined pattern may be associated with a first operating state, a second pre-determined pattern may be associated with a second operating state, a third pre-determined pattern may be associated with a third operating state, etc. The operating states, may include a power-up operating state, an activation state, a power-down or sleep state, etc. The controller 18 may be programmed to control the signal generator 20 to generate signals having any of these pre-determined signal patterns. The activation state may be the operation of the device, which may be a valve, a data recorder, a flood light, etc.

The methods and devices of the present disclosure may be utilized with any type of node control system that utilizes an earthen formation to transmit control signals. For ease of explanation, the present teachings are discussed in the context of a seismic data acquisition system.

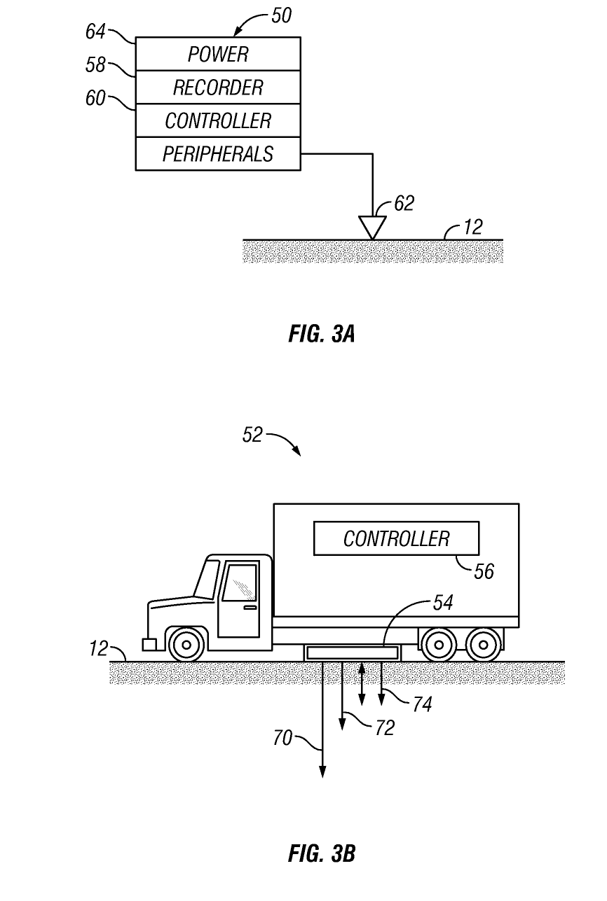

Referring now to FIGS. 3A and 3B, there is shown an exemplary seismic data acquisition node 50 and a signal generator 52. While only one node 50 is shown in FIG. 3A, it should be understood that multiple nodes 50 numbering in the hundreds, or even thousands, of such nodes may be distributed over a geographical area of interest. The nodes may be arranged in a precise grid or array or may be scattered asymmetrically with varying densities of nodes. Similarly, while one signal generator 52 is shown, a bank or group of signal generators 52 may be utilized. In embodiments, the signal generator 52 may be a mobile vehicle that is equipped with a vibration device 54 that is mechanically coupled to the earth 12. The vibration device 54 may include a controller 56 that is programmed to operate the vibration device 54 to generate any type of signal, including those shown in FIG. 2, or some other signal type or pattern.

The node 50 may operate as a self-contained seismic data acquisition unit configured to detect seismic energy. In embodiments, the node 50 may be configured to operate in one of several operating modes. Exemplary operating modes may include power off all systems, deep sleep to keep only limited components energized, sleep to non-essential components powered off, record data, stop recording data, transmit data, dump data, reset all systems, calibrate the system, transmit a signal for reporting status, and full active mode wherein all components are operational. Thus, in embodiments where the node 50 does not include a communication device, such as a radio receiver, the operating state of the node 50 may be controlled by transmitting seismic signals through the earth 12. In embodiments, the node 50 may include a communication device, such as a RF device. In such embodiments, the communication device may function as a primary communication link, a secondary communication link, or a specialized communication link.

The node 50 may include a recorder 58 for recording the measured seismic data, a controller 60, a receiver 62 and a power signal generator 64. The controller 60 processes the signals from the receiver 62 to create storable information indicative of the seismic energy sensed at the receiver 62. The information may be in digital form for storage in the recorder 58. The recorder 58 may include a memory, such as a nonvolatile memory of sufficient capacity for storing information for later transfer or transmission. The memory might be in the form of a memory card, removable miniature hard disk drive, an Electrically-Erasable Programmable Read Only Memory (EEPROM) or the like. The receiver 62 may include a multi-component sensor that includes a three-component accelerometer sensor incorporating micro electro-mechanical systems (MEMS) technology and application-specific integrated circuits (ASIC) as found in the Vectorseis sensor module available from Input/Output, Inc., Stafford, Tex. The present disclosure, however, does not exclude the option of using velocity sensors such as a conventional geophone or using a pressure sensor such as a conventional hydrophone. Any sensor capable of sensing seismic energy will provide one or more advantages of the present disclosure. Local power is provided by a power supply circuit that includes an on-board rechargeable battery. Additionally or alternatively, power may be supplied by an external power supply and/or a power supply that is shared by two or more nodes 50. The node 50 may also include power management circuitry that shifts the node 50 between one or more selected levels of power use: e.g., a sleep mode wherein only the “wake” circuitry is energized to a high-active mode wherein the receiver 62 may detect seismic energy.

Because the nodes 50 may be scattered over tens of miles, it may be impractical to use human personnel to actuate each of the nodes individually. Moreover, leaving the nodes 50 in a state of high power usage may drain the power signal generator 64 too quickly. Thus, in embodiments, the signal generator 52 may be utilized to control functions such as the operating state of seismic nodes 50 to manage power usage and in-field operation.

In an exemplary mode of operation, the nodes 50 may be in a deep sleep mode to conserve power. For example, only the receiver 62 and portions of the controller 60 required to process data from the receiver 62 may be energized. The signal generator 52 may transmit a first seismic signal 70 to “wake up” the nodes 50. The signal generator 52 may thereafter transmit a signal 72 to instruct the nodes 50 to begin recording seismic data. With the nodes 50 in recording mode, the signal generator 52 may impart seismic energy into the earth 56. The reflected seismic waves may be recorded in the recorder 58. Upon collecting the required data, the signal generator 52 may transmit a signal 74 to instruct the nodes 50 to stop recording. Thus, it should be appreciated that the signal generator 52 may operate as both the signal generator for the seismic energy as well as a device for communication with the nodes 50. In effect, the energy waves transmitted by the signal generator 52 and received by the nodes 50 can include two distinct types of information: information relating to the characteristics of a subsurface formation, and information for controlling the operation of a node 50.

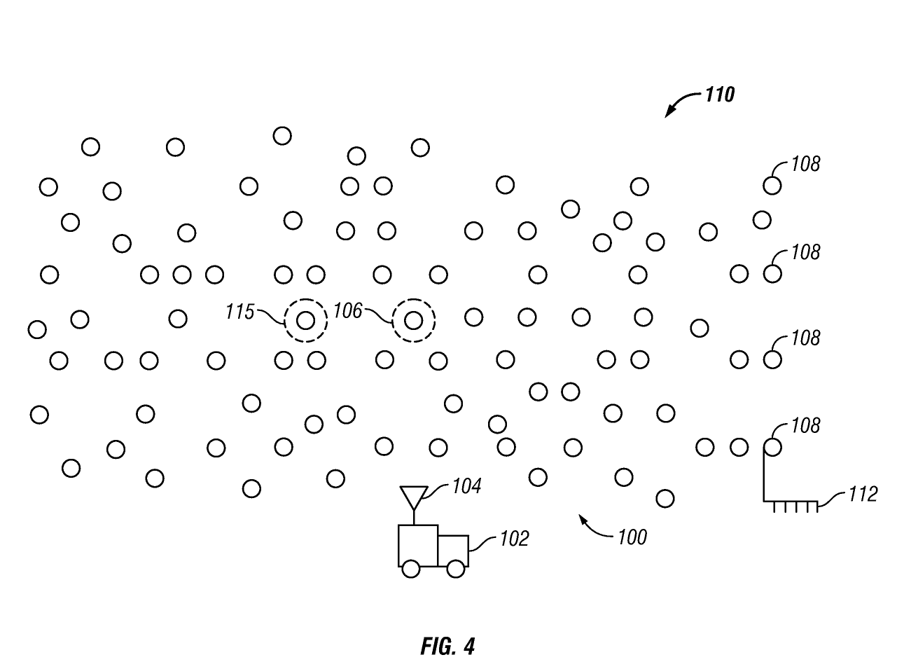

Referring to FIG. 4 there is schematically shown a node-based seismic data acquisition system 100 that may utilize the teachings of the present disclosure. The system 100 includes a central controller 102 remotely located from a plurality of station units 108. Each station unit 108 includes a receiver 62 (FIG. 3A), which may be coupled to the earth for sensing seismic energy in the earth. The sensed seismic energy may be energy waves reflected from subsurface formations. The seismic energy may be produced by a seismic signal generator 106, e.g., pyrotechnic source, vibrator truck, air gun, compressed gas, etc., to provide seismic energy of a known magnitude and source location.

The system 100 may include a central controller 102 in direct or indirect communication with one or more of the wireless sensor stations 108 that form an array (spread) 110 for seismic data acquisition. The array may utilize asymmetric distribution or an asymmetric grid distribution as shown. Asymmetric distributions, which may in one sense be characterized as a non-uniform spacing between at least some of the nodes or stations 108, may be advantageous when the in-field environment has obstacles (e.g., rivers or dense foliage) and/or when it may be desirable to acquire a relatively large amount of information from a defined area. In one embodiment, the central controller 102 issues instructions to the seismic signal generator 106 or personnel operating the seismic signal generator 106 to transmit a desired command or signal to the sensor stations 108. The communication may be in the form of radio signals transmitted and received at the central controller 102 via a suitable antenna 104. The term “seismic devices” includes any device that is used in a seismic spread, including, but not limited to, sensors, sensor stations, receivers, transmitters, power supplies, control units, etc.

In response to the instructions issued by the central controller 102, the seismic signal generator 106 may be operated to impart encoded signals or instructions into the ground. The encoded signals may be received at the sensor stations 108 (or nodes) and decoded. The sensor stations 108 thereafter take any necessary actions. For example, the encoded signal may be for the seismic spread 110 to “wake up” and transition to a record mode. Once the seismic spread 110, or a portion of the seismic spread 110, is in the record mode, the seismic signal generator 106 may impart seismic energy into the ground. The sensor stations 108 measure and record the seismic energy that is reflected from any subsurface formations. At some point, the seismic signal generator 106 may issue additional instructions to the seismic spread 110, such as to power down or turn off. Thus, in embodiments, the seismic signal generator 106 functions as both a communication device and a device for imparting seismic energy that is used to characterize subsurface formations. In other embodiments, two separate devices may be used. For example, the seismic signal generator 106 may be used to impart seismic energy for characterizing surface formations and a separate communication device 115 may be used to transmit instructions to the spread 110 using the earth as the transmission medium.

From the above, it should be appreciated that what has been described includes, in part, a method of conducting a seismic survey. The method may include operatively coupling a receiver and a controller to form a node; programming the controller to operate the node in response to receiving a controlled signal received by the receiver; acoustically coupling the receiver to the earth; acoustically coupling a seismic source to the earth; operating the seismic source to transmit the controlled signal into the earth; detecting the predetermined signal in the earth using the receiver; processing the detected controlled signal using the controller; and operating the node using the controller. In aspects, the controlled signal includes a first signal and a second signal different from the first signal; and operating the node may include operating the node in a first mode when the receiver detects the first signal and operating the node in a second mode different from the first mode when the receiver detects the second signal.

What has been described also includes, in part, a method of controlling a plurality of devices that may be distributed symmetrically or asymmetrically over a region of interest. The devices may be any device that is autonomous or semi-autonomous. The device may also be fully controllable; i.e., passive until instructed to operate. Exemplary devices may include mechanically actuated devices, hydraulically actuated devices, electronic devices, etc.

In one embodiment, the method may include configuring the devices to respond to a controlled signal; positioning the devices in an area of interest; and transmitting the controlled signal into the earth. In aspects, the controlled signal may be encoded with an instruction to operate in a desired operating state. The devices may transition to that operating state if in a different operating state or remain in a prior operating state. The method may also include encoding the controlled signal with data; and processing the controlled signal to select the operating state. In arrangements, the method may include controlling a signal generator to transmit the controlled signal. That is, one or more characteristics of a signal is controlled to have a desired shape, amplitude, etc. The signal generator may be a vibrating device. Exemplary vibrating devices may utilize a hydraulic actuator, a pneumatic actuator, and/or an electric actuator. In arrangements, the method may further include programming a controller to control the signal generator. An illustrative controlled signal may have: a fixed frequency; a fixed amplitude, a fixed wave form, a modulated frequency, a modulated amplitude, a modulated wave form, and/or a predetermined duration.

In variants, the method may include positioning the signal generator at the region of interest; transmitting the controlled signal into the earth using the signal generator; operating the signal generator to impart seismic energy into the earth; and detecting seismic data using one or more of the devices. One or more of the devices may shift into a recording mode of operation upon detecting the controlled signal. In some applications, the seismic energy may be seismic waves that have reflected from an underground formation.

In aspects, the present disclosure provides a system for remotely controlling devices by using the earth as a signal transmission medium. The system may include a plurality of nodes configured to select an operating state in response to receiving a controlled signal; and a signal generator configured to transmit the controlled signal into an earthen formation. The system may further include a processor configured to control the signal generator. The processor may be programmed with instructions to operate the signal generator to transmit the controlled signal. In arrangements, the signal generator may be configured to impart seismic energy into the earthen formation. In arrangements, each device may include a receiver configured to sense seismic vibrations, and the system may include processor associated with each device. The processor may be programmed with instructions to control its associated device in response to signals detected by the receiver.

In aspects, the present disclosure also provides a method of controlling a plurality of nodes. The nodes may be positioned in an asymmetric pattern, a symmetric pattern or a hybrid pattern that uses both symmetric and non-symettric positioning. The method may include operably coupling each node to a node controller; configuring each node controller to respond to a controlled signal; positioning the plurality of nodes in an area of interest; connecting each node to the earth; operably coupling a controller to a signal generator; connecting the signal generator to the earth; and controlling the signal generator with the controller to transmit the controlled signal into the earth. In aspects, each node controller may select an operating state from a plurality of different operating states based on the controlled signal. In arrangements, the method may include detecting the controlled signal with a seismic sensor. In aspects, the method may further include recording seismic data at each of the plurality of nodes.

While the particular disclosure as herein shown and disclosed in detail is fully capable of obtaining the objects and providing the advantages hereinbefore stated, it is to be understood that this disclosure is merely illustrative of the presently described embodiments of the disclosure and that no limitations are intended other than as described in the appended claims.

What is claimed is:

1. A method of controlling a plurality of devices, comprising:
configuring the plurality of devices to respond to a controlled signal;
positioning the plurality of devices in an area of interest;
communicating instructions to a seismic signal generator wirelessly; and
transmitting the controlled signal into the earth by the seismic signal generator in response to the instructions.

2. The method of claim 1 further comprising encoding the controlled signal with an instruction to operate in a specified operating state.

3. The method of claim 2 further comprising encoding the controlled signal with data; and processing the controlled signal to select the operating state.

4. The method of claim 1 further comprising controlling a signal generator to transmit the controlled signal.

5. The method of claim 4 wherein the signal generator is a vibrating source.

6. The method of claim 5 wherein the vibrating source uses one of: (i) a hydraulic actuator, (ii) a pneumatic actuator, and (iii) an electric actuator.

7. The method of claim 4 further comprising programming a controller to control the signal generator.

8. The method of claim 1 wherein the controlled signal is selected from a group consisting of: (i) a fixed frequency; (ii) a fixed amplitude, (iii) a fixed wave form, (iv) a modulated frequency, (v) a modulated amplitude, (vi) a modulated wave form, and (vii) a predetermined duration.

9. The method of claim 1, further comprising:
positioning a signal generator at the region of interest;
transmitting the controlled signal into the earth using the signal generator, wherein at least one device of the plurality of devices shifts into a recording mode of operation upon detecting the controlled signal;
operating the signal generator for a predetermined period to impart seismic energy into the earth;
detecting seismic data using at least one device of the plurality of devices.

10. A system for remotely controlling devices using the earth as a signal transmission medium, comprising:
(a) a plurality of nodes configured to select an operating state in response to receiving a controlled signal; and
(b) a signal generator configured to transmit the controlled signal into an earthen formation in response to instructions; and
(c) a controller configured to issue the instructions to the seismic signal generator wirelessly.

11. The system of claim 10 further comprising a processor configured to control the signal generator, the processor being programmed with instructions to operate the signal generator to transmit the controlled signal.

12. The system of claim 10 wherein the controlled signal includes one of: (i) a fixed frequency; (ii) a fixed amplitude, (iii) a fixed wave form, (iv) a modulated frequency, (v) a modulated amplitude, and (vi) a modulated wave form.

13. The system of claim 10 wherein the signal generator is configured to impart seismic energy into the earthen formation.

14. The system of claim 10 wherein each node includes an associated receiver configured to sense seismic vibrations, and further comprising a processor associated with each node, each processor being programmed with instructions to control its associated node in response to signals from the associated receiver.

15. A method of controlling a plurality of nodes, comprising:
operably coupling each node to a node controller;
configuring each node controller to respond to a controlled signal;
positioning the plurality of nodes in an area of interest;
connecting each node to the earth;
connecting a signal generator to the earth; and
wirelessly instructing the signal generator to transmit the controlled signal into the earth.

16. The method of claim 15 further comprising configuring each node controller to select an operating state from a plurality of different operating states based on the controlled signal.

17. The method of claim 15 further comprising detecting the controlled signal with a seismic sensor.

18. The method of claim 15 further comprising recording seismic data at each of the plurality of nodes.

19. The method of claim 15 wherein the plurality of nodes are positioned in an asymmetric pattern.
